(19) United States
(12) Patent Application Publication
(10) Pub. No.: US 2011/0064632 A1
(43) Pub. Date: Mar. 17, 2011

(54) Staged Catalyst System and Method of Using the Same

(75) Inventors: Yinyan Huang, Northville, MI (US); Christine Kay Lambert, Dearborn, MI (US)

(73) Assignee: FORD GLOBAL TECHNOLOGIES, LLC, Dearborn, MI (US)

(21) Appl. No.: 12/558,738

(22) Filed: Sep. 14, 2009

(51) Int. Cl. B01D 53/94; F01N 3/035

(52) U.S. Cl. 423/212; 422/171

(57) ABSTRACT

One aspect of the present invention is directed to a staged catalyst system for reducing gases in the exhaust from a combustion engine. In one embodiment, the staged catalyst system includes an integrated particulate filter block supporting thereupon a first selective catalytic reduction catalyst; and a flow-through catalyst block supporting thereupon a second selective catalytic reduction catalyst, wherein the integrated particulate filter block is disposed downstream of the combustion engine and upstream of the flow-through catalyst block.

### BACKGROUND

1. Technical Field

The present invention relates to an emission control system for reducing waste products from the exhaust of a combustion engine.

2. Background Art

Like gasoline engines, diesel engines have been widely used for transportation and many other stationary applications. A combustion exhaust from diesel engines often contains a variety of combustion waste products including unburned hydrocarbon (HC), carbon monoxide (CO), particulate matter (PM), nitric oxide (NO), and nitrogen dioxide (NO₂), with NO and NO₂ collectively referred to as nitrogen oxide or NOₓ. Removal of CO, HC, PM, and NOₓ from the combustion exhaust is needed for cleaner emissions. The combustion exhaust treatment becomes increasing important in meeting certain emission requirements.

Conventional emission control systems often use separate devices for the reduction of NOₓ and particulate matter. For example, a singular SCR (selective catalytic reduction) catalyst is used for converting NOₓ to nitrogen (N₂) and a singular particulate filter (PF) is used for removing particulate matter.

However, conventional emission control systems have met with limited use as they lack, among other things, concurrent and balanced consideration for emission control efficiency and space conservation.

There is a continuing need to provide an emission control system with features more suitable for meeting increasingly stringent industry and environmental standards.

### SUMMARY

One aspect of the present invention is directed to a staged catalyst system for reducing waste products in the exhaust from a combustion engine. In one embodiment, the staged catalyst system includes an integrated particulate filter block supporting thereupon a first selective catalytic reduction catalyst; and a flow-through catalyst block supporting thereupon a second selective catalytic reduction catalyst, wherein the integrated particulate filter block is disposed downstream of the combustion engine and upstream of the flow-through catalyst block.

In at least another embodiment, the integrated particulate filter block and the flow-through catalyst block are spaced of no more than 120 centimeters apart.

In at least yet another embodiment, the first selective catalytic reduction catalyst has a loading concentration from 0.5 to 3.0 grams per cubic inch of the integrated particulate filter block. In certain instances, the first selective catalytic reduction catalyst is catalytically active for converting 85 percent or more by volume of NOₓ to nitrogen in a temperature range of 270 to 600 degrees Celsius. One example of the first selective catalytic reduction catalyst is an iron-containing zeolite.

In at least yet another embodiment, the second selective catalytic reduction catalyst has a loading concentration from 0.5 to 6.0 grams per cubic inch of the catalyst block. In certain instances, the second selective catalytic reduction catalyst is catalytically active for converting 85 percent or more by volume of NOₓ to nitrogen in a temperature range of 170 to 450 degrees Celsius. One example of the second selective catalytic reduction catalyst is a copper-containing zeolite.

According to another aspect of the present invention, there is provided an emission control system containing the staged catalyst system described herein for reducing gases transported in an exhaust passage from a combustion engine and a reductant source for introducing reductant within the exhaust passage downstream of the combustion engine.

According to at least yet another aspect of the present invention, there is provided a method for reducing gases in the exhaust of a combustion engine. In at least one embodiment, the method includes contacting the exhaust with a reductant and an integrated particulate filter block to form a first treated exhaust, the integrated particulate filter block containing thereupon a first selective catalytic reduction catalyst; and contacting the first treated exhaust with a flow-through catalyst block containing thereupon a second selective catalytic reduction catalyst to form a second treated exhaust.

### BRIEF DESCRIPTION OF THE DRAWINGS

FIGS. 1A-1B schematically depict configurations of an emission control system according to various embodiments of the present invention;

FIG. 2 shows the percentage of NOₓ removal as a function of catalytic temperature compared among catalyst configurations;

FIG. 3 shows the percentage of ammonia oxidation as a function of catalytic temperature compared among various catalyst configurations;

FIG. 4 shows ammonia slip, in ppm (parts per million), as a function of catalytic temperature compared among various catalyst configurations;

FIG. 5 shows the percentage of NOₓ removal as a function of catalytic temperature compared among SCR1/PF catalyst configurations having various NO/NO₂ ratios; and

FIG. 6 shows the percentage of NOₓ removal as a function of catalytic temperature compared among SCR2 catalyst compositions having various NO/NO₂ ratios.

### DETAILED DESCRIPTION

As required, detailed embodiments of the present invention are disclosed herein. However, it is to be understood that the disclosed embodiments are merely exemplary of the invention that may be embodied in various and alternative forms. The figures are not necessarily to scale, some features may be exaggerated or minimized to show details of particular components. Therefore, specific structural and functional details disclosed herein are not to be interpreted as limiting, but merely as a representative basis for the claims and/or a representative basis for teaching one skilled in the art to variously employ the present invention.

Moreover, except where otherwise expressly indicated, all numerical quantities in the description and in the claims are to be understood as modified by the word “about” in describing the broader scope of this invention. Practice within the numerical limits stated is generally preferred. Also, unless expressly stated to the contrary, the description of a group or class of material as suitable or preferred for a given purpose in connection with the invention implies that mixtures of any two or more members of the group or class may be equally suitable or preferred.

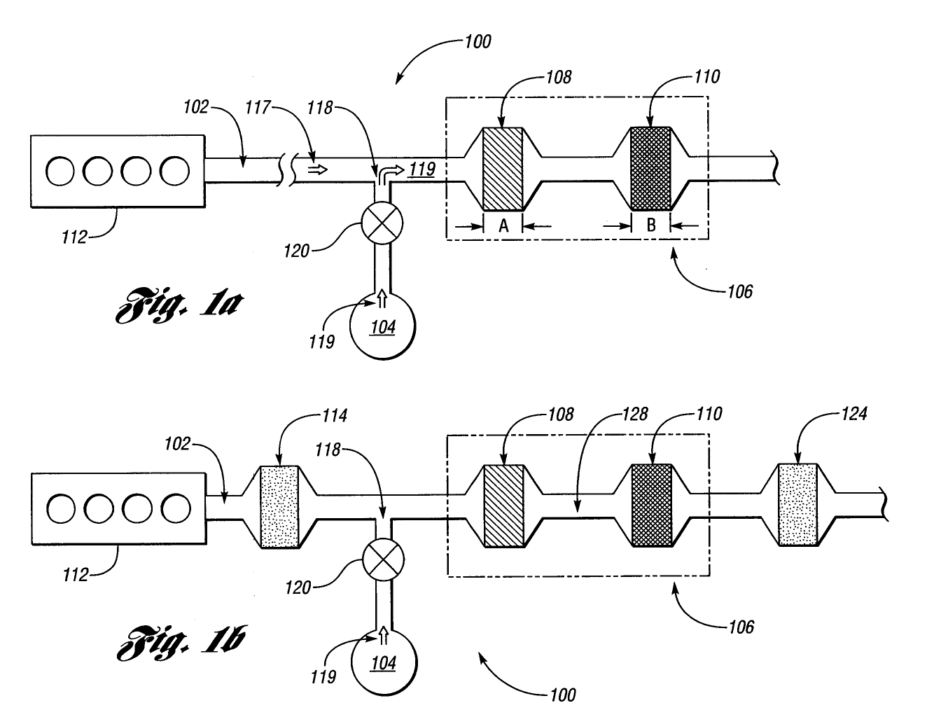

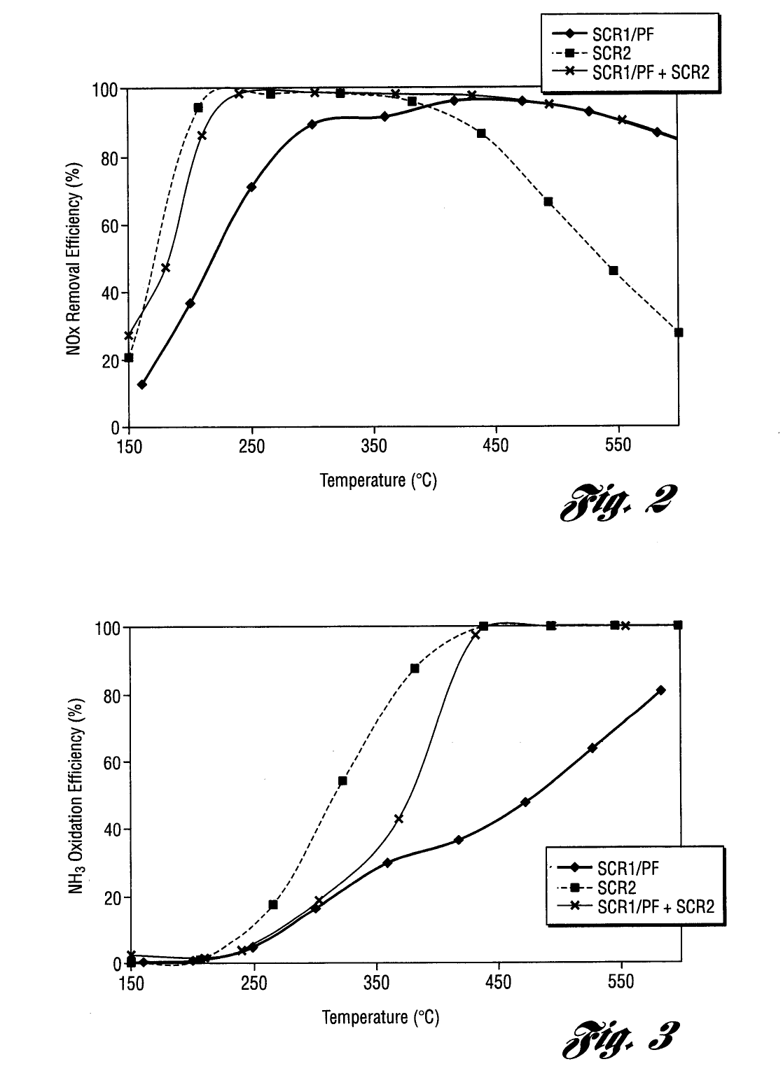

One aspect of the present invention is directed to a staged catalyst system, as generally shown at 106 in FIG. 1A-1B, for use in reducing waste products in the exhaust of a combustion engine and in one particular embodiment, a diesel engine. In at least one embodiment, the staged catalyst system 106 comprises a SCR1/PF 108 and a SCR2 110. It has been found that the staged catalyst system 106 as contemplated herein provides a synergistically broadened catalytic temperature range and hence enhanced NOₓ reduction efficiency in comparison to existing configurations. As illustrated in more detail below, the staged catalyst system 106 alleviates the occurrence of a sharp “fall-off” of NOₓ removal efficiency at a given temperature, a phenomenon often observed with singular SCR/PF devices. In addition, the integrated catalyst system 106 also exhibits NOₓ reduction in the 175 to 225 degrees Celsius temperature range, a range where SCR1/PF or SCR2 alone is typically catalytically inactive.

While not intended to be limited to any particularly theory, the synergistic broadening effect may be explained by the following: a close coupling of the SCR1/PF 108 upstream of the SCR2 110 induces at least a partial conversion of NOₓ and hence a change in the ratio between various species of NOₓ. As such, the resulting ratio of NO₂/NO is better suited for a downstream catalytic conversion by the SCR2 catalyst 110. In addition, it is believed that during an engine cold start, when the SCR1/PF catalyst 108 remains relatively less catalytically active, a reductant such as ammonia can slip through SCR1/PF 108 and SCR2 110 helps to act on the ammonia as leaked through and reduces its release out into the air. Finally, it is believed that the broadened catalytic temperature range is due at least in part to the flexibility of having separate SCR catalyst loadings provided by the staged catalyst system 106 with the “SCR1/PF+SCR2” configuration, wherein the first SCR catalyst “SCR1/PF” may be of a catalytic function that reacts well in a higher temperature range with a starting temperature of 250 degree Celsius, for instance. For a given amount of SCR catalyst loading needed for a particular application, the availability of a separate catalyst block, namely SCR2 110, to load share some portion of the required total SCR catalyst loading helps to relieve issues associated with back pressure build-up on the particulate filter block.

In practice, typically the closer the exhaust stream is to the engine 112, the hotter the exhaust gets. As such, SCR1/PF 108 is in contact with a substantially hotter exhaust than the second SCR catalyst in the SCR2 110 due to its relatively more downstream location. Accordingly, SCR1/PF 108 is designed to be catalytically active at a temperature range between 250 to 550 degrees Celsius—higher than the temperature range for SCR2 110. Likewise, the second SCR catalyst of the SCR2 110 is designed to be catalytically active within a lower temperature window than SCR1/PF 108, slated at a range of between 150 to 450 degrees Celsius.

The staged configuration of “SCR1/PF+SCR2” provides a certain degree of flexibility to an emission control system wherein the SCR catalyst as supported on the SCR1/PF block 108 and the SCR2 block 110 can be formulated to be of the same or different chemical composition such that the emission control system can be further optimized based on the catalyst selection and formulation thereof. For instance, Fe/zeolite is preferably used in the SCR1/PF block 108 and Cu/zeolite is preferably used in the SCR2 block 110. However, chemical compositions for the SCR1/PF block 108 and the SCR2 block 110 do not necessarily have to be restricted to Fe/zeolite or Cu/zeolite alone. It is reasonable, and dependent upon application particulars at hand, the SCR1/PF 108 can contain a mixture of Fe and Cu with any suitable weight ratio, for instance, of from 2:1, 3:1, 4:1, 5:1, 6:1, 7:1, 8:1, 9:1, to 10:1; the SCR2 can contain a mixture of Fe and Cu with any suitable weight ratio, for instance, of from 1:2, 1:3, 1:4, 1:5, 1:6, 1:7, 1:8, 1:9, or 1:10.

Furthermore, the staged catalyst system 106 “SCR1/PF+SCR2” according to at least one embodiment of the present invention provides substantial space reduction in a range of 20 to 40 percent relative to convention systems.

An additional benefit is that the staged catalyst system, “SCR1/PF+SCR2” enhances ammonia oxidation and further reduces ammonia slip past the emission control system. For mobile diesel engine applications, overdosing of ammonia is sometimes inevitable in practice. Any ammonia in excess of what can be consumed during the NOₓ conversion reactions should be eliminated or the excess ammonia can slip through the system and be released into to the air causing pollution. One way of eliminating the excess ammonia is via oxidization reactions wherein the noxious ammonia is oxidized into N₂ that is relatively safer to be released into the air.

As used herein and unless otherwise noted, the term DPF or DF refers to the particulate filter employed to remove particulate matter or the like.

The present invention is capable of reducing waste products from the exhaust of an internal combustion engine such as a diesel engine or a gasoline engine. The staged catalyst system 106, as described in more detail below, is believed to provide at least one of the following advantages including—a broadened catalytically active temperature range; more adequate mixing between the exhaust and the catalysts; and a reasonable reduction in the overall system complexity and space required.

In at least one embodiment, an emission control system uses a staged catalyst system illustrated as “SCR1/PF+SCR2”, which includes a first SCR catalyst (SCR1/PF) followed by a particulate filter with a second SCR catalyst (SCR2). The second SCR catalyst can be attached to a flow-through monolith and therefore, the exhaust flows through the monolith while being treated by the second SCR catalyst. The first SCR catalyst can be coated on a wall-flow PM filter and the resulting SCR1/PF block performs concurrently at least two functions, namely reduction of the NOₓ and removal of the particulate matter.

With respect to the Figures that will be described in detail below, like numerals are used to designate like structures throughout the Figures. An emission control system in accordance with at least one embodiment of the present invention is generally shown at 100 in FIG. 1A. The emission control system 100 includes an exhaust passage 102 and the staged catalyst system 106 described herein. In the illustrated embodiment, a reductant 119 is disposed within the exhaust passage 102 downstream of an engine 112. An aperture 118 is optionally located on the exhaust passage 102 and disposed between the engine 112 and the staged catalyst system 106 to facilitate the introduction of the reductant 119 into the exhaust passage 102. The reductant 119, capable of reducing NOₓ to nitrogen N₂, is injected into the exhaust passage 102 optionally through a nozzle (not shown). The injection of the reductant 119 is optionally achieved through the use of a valve 120 which can be employed to meter needed amounts of the reductant 119 into an exhaust 117 from a reductant source 104. The exhaust 117 with the reductant 119 is then conveyed further downstream to the staged catalyst system 106 for the reduction of NOₓ and the removal of the particulate matter.

In at least one embodiment, the aperture 118 is disposed no more than 140 centimeters upstream of the SCR1/PF block 108. In at least another embodiment, the aperture 118 is disposed no more than 100 centimeters upstream of the SCR1/PF block 108.

In at least another embodiment, the range of the distance between the aperture 118 and the SCR1/PF block 108 may be independently selected from a range of no less than 0.5 centimeters, 10 centimeters, 20 centimeters, 30 centimeters, 40 centimeters, 50 centimeters, 60 centimeters, or 70 centimeters, to no greater than 140 centimeters, 130 centimeters, 120 centimeters, 110 centimeters, 100 centimeters, 90 centimeters, or 80 centimeters.

The reductant 119 may be of any material suitable for reducing NOₓ to a harmless, releasable substance such as nitrogen N₂. Exemplary reducing agents are hydrocarbon (HC), ammonia (NH₃), an ammonia precursor such as liquid urea, or any combination thereof. As is known, when exposed to a warm or hot exhaust, urea readily decomposes to ammonia. In certain embodiments, a molar ratio NH₃/NOₓ is typically kept at a value predesignated so as to minimize NH₃ slip past the catalysts and out into the air. An exemplary molar ratio of NH₃/NOₓ is at or near one (1). Decomposition of urea and subsequent reduction of NOₓ typically occurs according to the following scheme:

Urea decomposition:

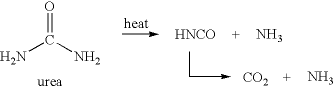

NOₓ reduction:

4NO+4NH₃+O₂→4N₂+6H₂O

6NO₂+8NH₃→7N₂+12H₂O

2NH₃+NO+NO₂→2N₂+3H₂O

Any suitable SCR catalyst compositions can be used in the SCR1/PF 108 and the SCR2 110 to catalyze the reduction of NOₓ. In certain instances, the SCR catalysts are capable of converting at least 50% of NOₓ to nitrogen (N₂), depending on the amount of the reductant 119 supplied. Useful SCR catalysts should have thermal resistance to temperatures greater than 650 degree Celsius so that the SCR catalysts remain structurally integral throughout an exhaust treatment process.

As used herein and unless otherwise identified, a SCR catalyst is “catalytically functional” in a given temperature when at that temperature, the SCR catalyst is able to convert 50 percent or more by volume of NOₓ to nitrogen.

As used herein and unless otherwise identified, a SCR catalyst is “catalytically active” in a given temperature when at that temperature, the SCR catalyst is able to convert 85 percent or more by volume of NOₓ to nitrogen.

In at least one embodiment, the first SCR catalyst 108 is catalytically functional in a temperature range of about 150 to 650 degrees Celsius and in at least another embodiment is catalytically active for converting 85 percent or more by volume of NOₓ to nitrogen in a temperature range of 270 to 600 degrees Celsius.

In yet at least one embodiment, the second SCR catalyst of the SCR2 block 110 is catalytically functional in a temperature range of about 150 to 650 degrees Celsius and in at least another embodiment is catalytically active for converting 85 percent or more by volume of NOₓ to nitrogen in a temperature range of 170 to 450 degrees Celsius. The catalytically active temperature range for the second SCR catalyst of the SCR2 block 110 is generally lower in contrast with the range for the first SCR catalyst of the SCR1/PF block 108. This is beneficial at least in that the staged catalyst distribution provided by the staged catalyst system 106 responds to a similarly staged operating temperature profile, e.g., in a gradually cooling fashion along the exhaust passage 102 as the exhaust 117 proceeds downstream from the engine 112.

Suitable SCR catalysts are described in U.S. Pat. No. 4,961,917 to Byrne, the entire content of which is incorporated by reference herein. Some suitable compositions include one or both of an iron and a copper metal atom present in a zeolite in an amount of from about 0.1 to 30 percent by weight of the total weight of the metal atoms plus zeolite. Zeolites are resistant to sulfur poisoning and remain active during a SCR catalytic reaction. Zeolites typically have pore sizes large enough to permit adequate movement of NOₓ, ammonia, and product molecules N₂ and H₂O. The crystalline structure of zeolites exhibits a complex pore structure having more or less regularly recurring connections, intersections, and the like. By way of example, suitable zeolites are made of crystalline aluminum silicate, with a silica to alumina ratio in the range of 5 to 400 and a mean pore size from 3 to 20 Angstroms.

Suitable SCR catalyst to be used in the staged catalyst system 106 may be a physical mixture of two or more catalysts in any suitable ratio. By way of example, the first SCR catalyst 108 of the staged catalyst “SCR1/PF+SCR2” system 106 can be an iron-containing zeolite combined with one or more other metals selected from the group consisting of vanadium, chromium, molybdenum, tungsten, or any combinations thereof. Similarly, the SCR2 catalyst of the staged catalyst “SCR1/PF+SCR2” system 106 can be a copper-containing zeolite combined with one or more other metals selected from the group consisting of vanadium, chromium, molybdenum, tungsten, or any combinations thereof.

Monoliths are well known but are generally described as a ceramic block made of a number of parallel tubes. The monolith may be made of ceramic materials such as cordierite, mullite, and silicon carbide or metallic materials such as iron cromium alloy, stainless steel, and Inconel®. The individual tubes of the monolith may be of any suitable size, and in certain embodiments are of a size of 0.5 to 10 millimeters in diameter.

Because of the number of the passages, the contact area between an exhaust and the first SCR catalyst is relatively high. Further, the tubes are substantially straight, hollow, and parallel to the flow of the exhaust, therefore flow obstruction to the exhaust is effectively minimized.

In at least one embodiment, the SCR1/PF block 108 is provided with a SCR catalyst loading concentration in grams per cubic inch of a loading volume, generally shown at “A” in FIG. 1A. In certain instances, the SCR1/PF block 108 has a SCR catalyst loading concentration in a range independently selected from no less than 0.5 g/in³, 1.0 g/in³, or 1.5 g/in³, to no greater than 2.0 g/in³, 2.5 g/in³, or 3.0 g/in³.

In at least another embodiment, the SCR2 block 110 is provided with a SCR catalyst loading concentration in grams per cubic inch of a loading volume, generally shown at “B” in FIG. 1A. In certain instances, the SCR2 block 110 has a SCR catalyst loading concentration in a range independently selected from no less than 0.5 g/in³, 1.0 g/in³, 1.5 g/in³, 2.0 g/in³, to no greater than 6.0 g/in³, 5.0 g/in³, 4.0 g/in³, or 3.0 g/in³.

In at least another embodiment, the ratio of the SCR catalyst loading concentration of the SCR1/PF 108 relative to the loading concentration of the SCR2 110 is 0.1 to 3.0, in another embodiment of 0.5 to 2.8, and in another embodiment of 1.0 to 2.5.

In at least another embodiment, the distance between the SCR1/PF 108 and the SCR2 110 may be independently selected from no less than 0.5, 10 centimeters, 20 centimeters, 30 centimeters, 40 centimeters, 50 centimeters, or 60 centimeters, to no greater than 70 centimeters, 80 centimeters, 90 centimeters, 100 centimeters, 110 centimeters, or 120 centimeters.

In at least one embodiment, the first SCR catalyst is supported on a wall-flow particulate filter to form the SCR1/PF block having a plurality of substantially parallel tubes extending along the longitudinal axis of the particulate filter. Typically, each tube is blocked at one end of the particulate filter, with alternate passages blocked at opposite ends. An exemplary wall-flow particulate filter is composed of ceramic-like materials such as cordierite, α-alumina, silicon carbide, silicon nitride, zirconia, mullite, spodumene, alumina-silica-magnesia, or zirconium silicate. The pore sizes and level of porosity are selected to allow flow exchange through the pores while ensuring that all back pressure on the particulate filter to be at a minimum.

The SCR catalyst can be coated onto the SCR1/PF block 108 or the SCR2 block using any suitable method. One exemplary method of such a coating is illustrated in U.S. Pat. No. 7,229,597 to Patchett et al., the entire contents of which are incorporated herein by reference. In essence, the particulate filter with a desired porosity is immersed in a catalyst slurry which is then allowed to dry under compressed air. This dipping-drying process may be repeated till the desired level of coating is achieved. After coating, the particulate filter may be dried at a temperature of 100 degrees Celsius and subsequently calcined at a temperature in the range of 300 to 500 degrees Celsius.

In at least one embodiment, and as shown in FIG. 1B, an oxidation catalyst 114 can be disposed within the exhaust passage 102 between the engine 112 and the aperture 118. Oxidation catalysts that contain platinum group metals, base metals and combinations thereof promotes the conversion of both HC and CO gaseous pollutants and at least some portion of the particulate matter through oxidation of these pollutants to carbon dioxide and water. The oxidation catalyst 114 generally helps to break down pollutants in the exhaust to less harmful components. In particular, the oxidation catalyst 114 utilizes palladium and platinum catalysts to mainly help reduce the unburned hydrocarbon and carbon monoxide according to the following reaction formula: CO+O2→CO2.

When the oxidation catalyst 114 is used as illustrated in FIG. 1B, an exhaust containing unburned hydrocarbons (HC), carbon monoxide (CO), nitrogen oxide (NOₓ), and particulate matter (PM) is emitted from the engine 112 through exhaust passage 102 to the oxidation catalyst 114. In the oxidation catalyst 114, unburned hydrocarbon and carbon monoxide are combusted to form carbon dioxide and water. Removal of the HC and CO using the oxidation catalyst 114 helps to relieve some burden on the downstream staged catalyst system 106 in remediating the exhaust.

In addition, the oxidation catalyst 114 also converts a certain portion of the nitric oxide NO to nitrogen dioxide NO₂ such that the NO/NO₂ ratio is more suitable for downstream SCR catalytic reactions. An increased proportion of NO₂ in the NOₓ, due to the catalytic action of the upstream oxidation catalyst 114, enhances the reduction of NOₓ as compared to exhaust streams containing smaller proportions of NO₂ in the NOₓ component. Furthermore, the oxidation catalyst 114 helps to regenerate particulate filter 110 for continuous engine operation. During diesel engine operation, soot typically will accumulate on the particulate filter 110 over time and cause back pressure elevation which diminishes the full operating efficiency of the engine. One solution is to generate a sufficiently high temperature in the range of about 600 to 700 degrees Celsius to induce the combustion of the soot by injecting fuel onto the oxidation catalyst 114.

The staged catalyst system 106 may be further altered in its configuration without materially changing its intended function.

As shown in FIG. 1B, a second oxidation catalyst 124 can be disposed downstream of the staged catalyst system 106. When used in concert with the first oxidation catalyst 114, the second oxidation catalyst 124 mainly serves to oxidize ammonia molecules that may have slipped through the exhaust passage 102 and to convert the slipped ammonia molecules to N₂. In addition, any unburned hydrocarbon that is left untreated may be oxidized at this point before final release into the air.

One or more embodiments of the present invention are further illustrated by the following non-limiting examples.

### EXAMPLE

### Example 1

Catalytic efficiency testing is carried out in a steady state whereas the catalysts used are in a non-aged or fresh condition; whereas ammonia is supplied at a level of 350 ppm (parts per million); whereas a simulated exhaust stream is provided to have 350 ppm NOₓ; and whereas other testing parameters are set as follows: 14% of oxygen, 5% of carbon dioxide, 4.5% of water, and nitrogen to balance. The term “SCR1/PF+SCR2” represents an integrated particulate filter and SCR system whereas the first SCR catalyst as denoted “SCR1/PF” is an iron-containing zeolite coated on a diesel particulate filter and the SCR2 stands for the second SCR catalyst, with the second SCR catalyst being a copper-containing zeolite. The integrated particulate filter and SCR system is tested at a space velocity of 30,000 per hour or 30 K/h.

Space velocity is defined as v/V whereas v is the flow rate of an exhaust expressed in the unit of liter per hour and V is the volume of catalysts within a portion of the exhaust passage through which the exhaust passes. In this experiment, an exhaust travels in a flow rate of 6.44 liters per minute and the SCR1/PF is provided in a volume of 1 cubic inch, then the resulting space velocity is (6.44 L/min)(60 min)/(0.01287 L) which equals approximately 30K per hour. The testing is conducted in parallel comparison to SCR1/PF alone or to SCR2 alone. It is noted that in the “SCR1/PF+SCR2” configuration that the exhaust flow rate doubled to 12.88 liters per minute to maintain a space velocity of 30K per hour. When the amount of exhaust and hence the exhaust flow rate remains the same, for example, 6.44 liters per minute, “SCR1/PF+SCR2” at 15K per hour, space velocity is comparable to SCR1/PF alone of 30K per hour space velocity or SCR2 alone of 30K per hour space velocity. For the purpose of the experiments disclosed herein, a less than maximum amount of NOₓ is supplied through the exhaust; or put in a different way, the SCR1/PF, the SCR2, and the SCR1/PF+SCR2 at the space velocity of 30 K/h are each capable of converting the entire amount of the NOₓ under a suitable operating temperature.

FIG. 2 depicts NOₓ efficiency as a function of operating temperatures in degree Celsius. At the space velocity of 30 K/h and to remove at least 90 percent by weight of the total NOₓ supplied, the SCR1/PF is catalytically active within a temperature range of about 285 to about 540 degree Celsius. A comparable range for the SCR2 catalyst is about 200 to about 420 degree Celsius.

In contrast, the integrated particulate filter and SCR system shown at “SCR1/PF+SCR2” has a temperature range from about 210 to about 540 degrees Celsius spanning 330 degrees—a range at least 110 degrees broader than the range for SCR2 alone and at least 75 degrees broader than the range for SCR1/PF alone.

### Example 2

The experiment is carried out under the same conditions set forth in Example 1 above. In this example, ammonia oxidation is being monitored. Ammonia oxidation is an alternative indication of how much ammonia is being consumed in the process of both reducing NOₓ and being oxidized by the oxygen in the exhaust. The ammonia that is not oxidized or consumed typically slips past the catalysts and is released into the air.

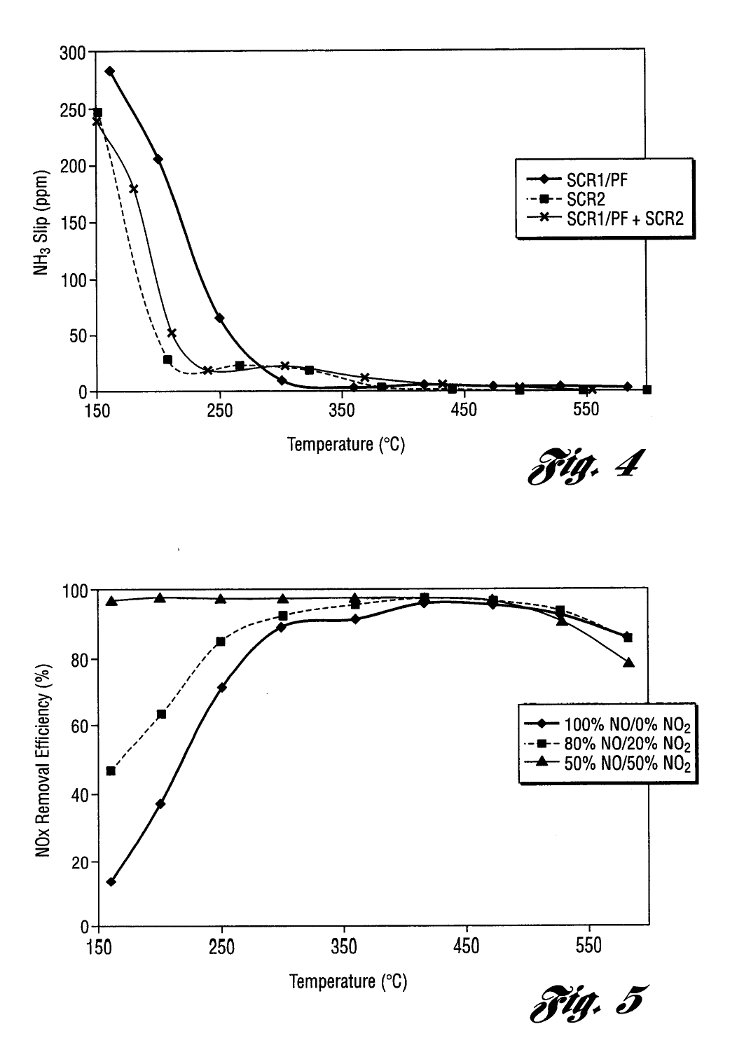

As depicted in FIG. 3, and within a temperature range of 150 to 550 degrees Celsius, ammonia (NH₃) usage through ammonia oxidation is the lowest in the SCR1/PF alone (and in this example, Fe/zeolite on DPF) and highest in the SCR2 alone (and in this example, Cu/zeolite) at a space velocity of 30 K/h. Fe/zeolite on DPF catalyst has comparably the lowest NH₃ oxidation activity even up to 500 degree Celsius while Cu/zeolite catalyst has higher NH₃ oxidation activity. At 30 K/h space velocity, 100% NH₃ removal efficiency is achieved at 440 degree Celsius. With the staged configuration, the NH₃ oxidation efficiency is shifted to high temperature but the 100% NH₃ removal efficiency is still achieved at 440 degree Celsius. The staged configuration, SCR1/PF+SCR2, affords relatively lower ammonia oxidation at cooler temperatures to favor rapid NOₓ conversion with NH₃ and at warmer temperatures, such as from 440 degrees Celsius and above, to favor ammonia slip control such that excess ammonia is oxidized to form less harmful N₂.

### Example 3

The experiment is carried out under the same conditions illustrated in Example 1 above. In this example, ammonia slip is being monitored. Amongst all four configurations tested and as shown in FIG. 4, the SCR1/PF alone configuration elicits the highest ammonia slip at temperatures in the range of 150 to 300 degrees Celsius. Ammonia slip in the SCR1/PF configuration quickly decreases to below 10 ppm at above 350 degree Celsius.

Since ammonia oxidation is generally reciprocal to ammonia slip in a given catalyst environment, the ammonia slip profile of the SCR 1 configuration shown in FIG. 4 is observed to be reciprocally consistent with the ammonia oxidation of the same SCR1/PF configuration as reported in FIG. 3. This is consistent with the activity of ammonia oxidation reported in FIG. 3 for SCR1/PF. All tested configurations exhibit minimum ammonia slip at a level at or below 50 ppm, when the catalyst temperature is at or above 250 degrees Celsius.

### Example 4

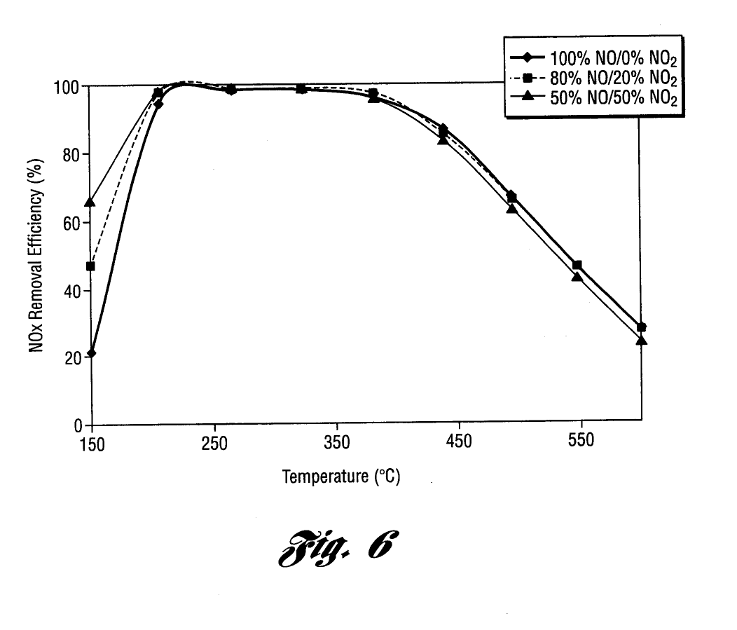

This experiment is carried out under the same conditions illustrated in Example 1 above. In this example, the NOₓ removal efficiency of the SCR1/PF block alone is examined as a function of operating temperature in degrees Celsius compared among various NO/NO2 composition ratios in the simulated exhaust stream. As shown in FIG. 5, when provided with a 50/50 stoichiometric mixture of NO/NO₂ in the simulated exhaust stream, the SCR1/PF alone elicits a 90% NOₓ removal at a temperature of 160 degree Celsius, in comparison to a temperature of 300 degree Celsius for the less stoichiometric comparables having NO/NO₂ ratios of 100%/0% and 80%/20%. The results demonstrated here are consistent with the finding that a partial conversion of NO to NO₂ to bring a NO/NO₂ ratio closer to a stoichiometry is beneficial for NOₓ conversion efficiency.

### Example 5

This experiment is carried out under the same conditions illustrated in Example 1 above. In this example, the NOₓ removal efficiency of the SCR2 block alone is examined as a function of operating temperature in degrees Celsius compared among various NO/NO₂ composition ratios in the simulated exhaust stream. As shown in FIG. 6, when provided with a 50/50 stoichiometric mixture of NO/NO₂ in the simulated exhaust stream, the SCR2 alone elicits generally higher NOₓ removal at a temperature of from 150 to 250° C., in comparison to the less stoichiometric comparables having NO/NO₂ ratios of 100%/0% and 80%/20%. The results demonstrated here are consistent with the finding that a partial conversion of NO to NO₂ to bring a NO/NO₂ ratio closer to a stoichiometry is beneficial for NOₓ conversion efficiency.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed:

1. A staged catalyst system for reducing waste products in the exhaust from a combustion engine, comprising:
an integrated particulate filter block supporting thereupon a first selective catalytic reduction (SCR1) catalyst; and
a flow-through catalyst block supporting thereupon a second selective catalytic reduction (SCR2) catalyst, wherein the integrated particulate filter block is disposed downstream of the combustion engine and upstream of the flow-through catalyst block.

2. The staged catalyst system of claim 1, wherein the integrated particulate filter block and the flow-through catalyst block are spaced of no more than 120 centimeters apart.

3. The staged catalyst system of claim 1, wherein the first selective catalytic reduction catalyst has a loading concentration from 0.5 to 3.0 grams per cubic inch of the integrated particulate filter block.

4. The staged catalyst system of claim 1, wherein the first selective catalytic reduction catalyst is catalytically active for converting 85 percent or more by volume of NOₓ to nitrogen in a temperature range of 270 to 660 degrees Celsius.

5. The staged catalyst system of claim 1, wherein the first selective catalytic reduction catalyst is an iron-containing zeolite.

6. The staged catalyst system of claim 1, wherein the second selective catalytic reduction catalyst has a loading concentration from 0.5 to 6.0 grams per cubic inch of the catalyst block.

7. The staged catalyst system of claim 1, wherein the second selective catalytic reduction catalyst is catalytically active for converting 85 percent or more by volume of NOₓ to nitrogen in a temperature range of 170 to 450 degrees Celsius.

8. The staged catalyst system of claim 1, wherein the second selective catalytic reduction catalyst is a copper-containing zeolite.

9. The staged catalyst system of claim 1, wherein a selective catalyst reduction catalyst loading ratio between the integrated particulate filter block and the flow-through catalyst block is from 0.1 to 3.0.

10. An emission control system for reducing waste products transported in an exhaust passage from a combustion engine, comprising:
a reductant source for introducing reductant within the exhaust passage downstream of the combustion engine;
an integrated particulate filter block disposed within the exhaust passage and downstream of the reductant, the integrated particulate filter block supporting thereupon a first selective catalytic reduction catalyst; and
a flow-through catalyst block disposed within the exhaust passage and downstream of the integrated particulate filter block, the flow-through catalyst block supporting thereupon a second selective catalytic reduction (SCR2) catalyst.

11. The emission control system of claim 10, wherein the integrated particulate filter block and the flow-through catalyst block are spaced of no more than 120 centimeters apart.

12. The emission control system of claim 10, wherein the reductant is introduced into the exhaust passage at a location no more than 140 centimeters upstream of the integrated particulate filter block.

13. The emission control system of claim 10, further comprising an oxidation catalyst disposed within the exhaust passage and upstream of the integrated particulate filter block.

14. The emission control system of claim 10, further comprising an oxidation catalyst disposed within the exhaust passage and downstream of the flow-through catalyst block.

15. The emission control system of claim 10, wherein the first selective reduction catalytic catalyst is an iron-containing zeolite.

16. The emission control system of claim 10, wherein the second selective reduction catalytic catalyst is a copper-containing zeolite.

17. A method for reducing gases in the exhaust of a combustion engine, the method comprising:
contacting the exhaust with a reductant and an integrated particulate filter block to form a first treated exhaust, the integrated particulate filter block containing thereupon a first selective catalytic reduction catalyst; and
contacting the first treated exhaust with a flow-through catalyst block containing thereupon a second selective catalytic reduction catalyst to form a second treated exhaust.

18. The method of claim 17, wherein the reductant is disposed within the exhaust passage downstream of the combustion engine and upstream of the integrated particulate filter block.

19. The method of claim 17 further comprising contacting the exhaust with an oxidation catalyst prior to contacting the exhaust with the integrated particulate filter block.

20. The method of claim 17 further comprising contacting the second treated exhaust with an oxidation catalyst.
